(19) United States
(12) Patent Application Publication
(10) Pub. No.: US 2014/0308123 A1
(43) Pub. Date: Oct. 16, 2014

(54) BEARING FOR ROTOR BLADE

(71) Applicant: SIKORSKY AIRCRAFT CORPORATION, Stratford, CT (US)

(72) Inventors: Eric Lucien Nussenblatt, Stamford, CT (US); Ryan Thomas Casey, San Diego, CA (US); Eric S. Parsons, New Haven, CT (US); David H. Hunter, Cheshire, CT (US)

(73) Assignee: Sikorsky Aircraft Corporation, Stratford, CT (US)

(21) Appl. No.: 13/861,001

(22) Filed: Apr. 11, 2013

(51) Int. Cl. B64C 27/04

(52) U.S. Cl. CPC B64C 27/04
USPC 416/1; 416/174

(57) ABSTRACT

A rotor blade assembly includes one or more flex-beam members and a torque tube surrounding the one or more flex-beam members and extending at least partially along a rotor blade assembly length. A pitch bearing assembly is supportive of the torque tube relative to the one or more flex-beam members and includes at least two outer bearing members secured to the torque tube and an inner bearing member positioned at least partially within the at least two inner bearing members and secured to the one or more flex beam members. A change in a stiffness of the inner bearing member changes one or more dynamic characteristics of the rotor blade assembly.

### BACKGROUND

The subject matter disclosed herein generally relates to rotors for aircraft use. More specifically, the subject disclosure relates to flexbeam rotors for helicopters or other rotorcraft.

In typical flexbeam helicopter rotors, a flexbeam extends from a rotor hub and is connected to a torque tube and blade via a bolted joint and a snubber type bearing at an inboard end of the torque tube located between the flexbeam and the torque tube. The snubber bearing positions the torque tube relative to the flexbeam for pitch change and flapping motion of the torque tube and react shear loads on the assembly. Such bearings are often elastomeric bearings with preloaded laminates of elastomeric material placed between the flexbeam and torque tube, and are configured such that the elastomer remains in compression throughout the entire load range. Such rotors are subject to vibrational modes during operation, the vibrational frequencies and mode shapes traditionally are tuned to desired placements by changing stiffness and/or mass of the rotor blades, flex beam, and/or torque tube. This method of tuning is not always particularly sensitive.

### BRIEF DESCRIPTION

In one embodiment, a rotor blade assembly includes a flex-beam member and a torque tube surrounding the flex-beam member and extending at least partially along a rotor blade assembly length. A pitch bearing assembly is supportive of the torque tube relative to the flex-beam member and includes at least two outer bearing members secured to the torque tube and an inner bearing member positioned between the at least two inner bearing members and secured to the flex beam member. A stiffness of the inner bearing member is selected to change one or more dynamic characteristics of the rotor blade assembly.

In another embodiment, a pitch bearing assembly for a blade assembly of a rotary-winged aircraft includes at least two outer bearing members secured to the rotor blade assembly and an inner bearing member located between the at least two outer bearing members to transfer load between the outer bearing members. A stiffness of the inner bearing member is selected to change one or more dynamic characteristics of the rotor blade assembly.

In yet another embodiment, a rotary-winged aircraft includes an airframe, a drive system, and a rotor assembly operably connected to the drive system. The rotor assembly includes a rotor hub and a plurality of rotor blade assemblies operably connected to the rotor hub. Each rotor blade assembly includes a flex-beam member and a torque tube surrounding the flex-beam member and extending at least partially along a rotor blade assembly length. A pitch bearing assembly is supportive of the torque tube relative to the flex-beam member and includes at least two outer bearing members secured to the torque tube and an inner bearing member positioned between the at least two inner bearing members and secured to the flex beam member. A stiffness of the inner bearing member is selected to change one or more dynamic characteristics of the rotor blade assembly.

In still another embodiment, a method of changing one or more dynamic characteristics of a rotor blade assembly includes securing at least two pitch bearing outer members to a torque tube of a rotor blade assembly. A stiffness of a pitch bearing inner member is selected, and the pitch bearing inner member is installed between the at least two pitch bearing outer members. The pitch bearing inner member is secured to a flex beam member of the rotor blade assembly, surrounded by the torque tube. One or more dynamic characteristics of the rotor blade assembly are changed by the selected stiffness of the pitch bearing inner member.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of an embodiment of a helicopter;

FIG. 2 is a cross-sectional view of an embodiment of a rotor hub and blade assembly;

FIG. 3 is another cross-sectional view of an embodiment of a rotor blade assembly for a helicopter;

FIG. 4 is yet another cross-sectional view of an embodiment of a rotor blade assembly for a helicopter;

FIG. 5 is an illustration of inner bearing member stiffness versus load share between flex beam members and torque tube of a rotor blade assembly; and

FIG. 6 is an illustration of vibration response of a rotor blade assembly having differing inner bearing member stiffnesses.

The detailed description explains embodiments of the invention, together with advantages and features, by way of example with reference to the drawings.

### DETAILED DESCRIPTION

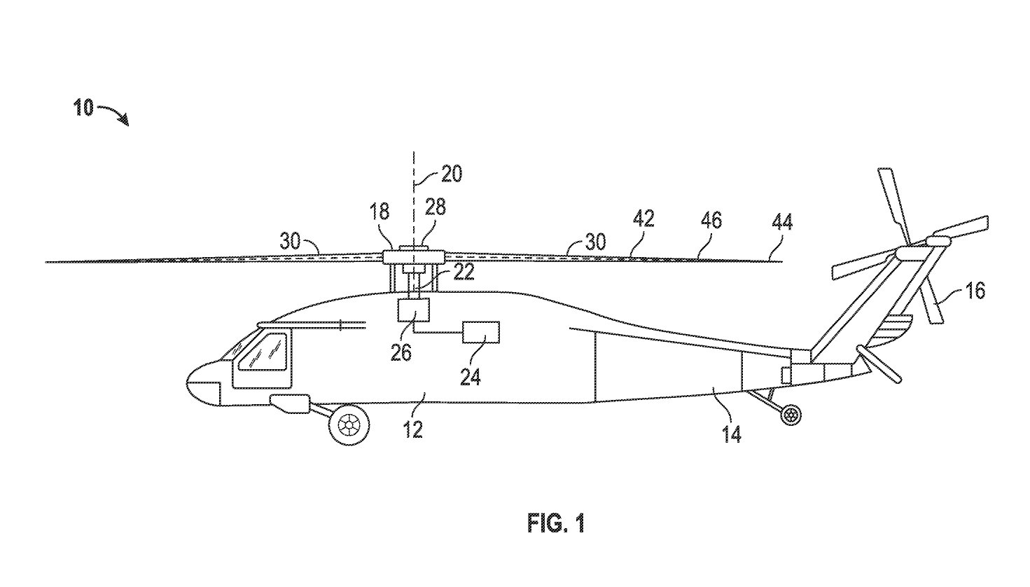

Shown in FIG. 1 is schematic view of an embodiment of a rotary-winged aircraft, in this embodiment a helicopter 10. The helicopter 10 includes an airframe 12 with an extending tail 14 and a tail rotor 16 located thereat. While the embodiment of a helicopter 10 described herein includes an extending tail 14 and tail rotor 16, it is to be appreciated that the disclosure herein may be applied to other types of rotor craft, such as coaxial, dual rotor rotorcraft. A main rotor assembly 18 is located at the airframe 12 and rotates about a main rotor axis 20. The main rotor assembly 18 is driven by a drive shaft 22 connected to a power source, for example, an engine 24 by a gearbox 26.

The main rotor assembly 18 includes a hub member 28 located at the main rotor axis 20 and operably connected to the drive shaft 22. A plurality of blade assemblies 30 are connected to the hub member 28.

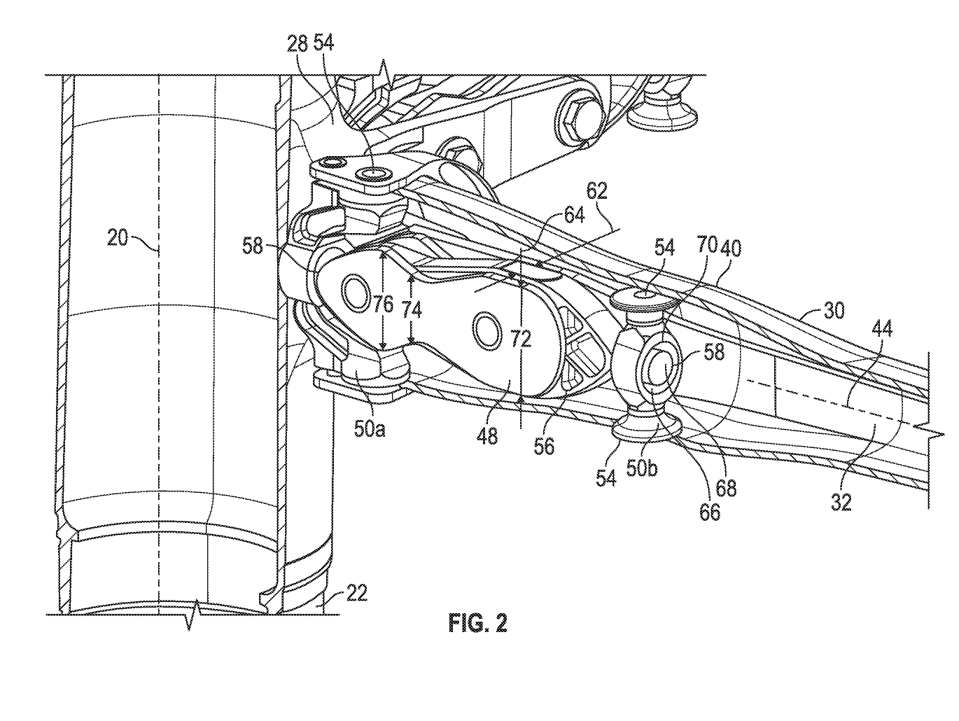

Referring now to FIG. 2, each blade assembly 30 includes at least one flex-beam member 32 secured to the hub member 28 and extending radially outwardly therefrom. A torque tube 40 is positioned around the flex-beam member 32 and extends radially outwardly along the flex-beam member 32. A rotor blade 42 has an airfoil-shaped cross section and is secured to the torque tube 40 and the flex-beam member 32 to extend radially outwardly along a blade axis 44 to a blade tip 46 (shown in FIG. 1). In some embodiments, the torque tube 40 and rotor blade 42 are assembled into a unitary assembly prior to installation over the flex-beam member 32. The torque tube 40 is positioned and supported relative to the flex-beam member 32 by a pitch bearing assembly 48.

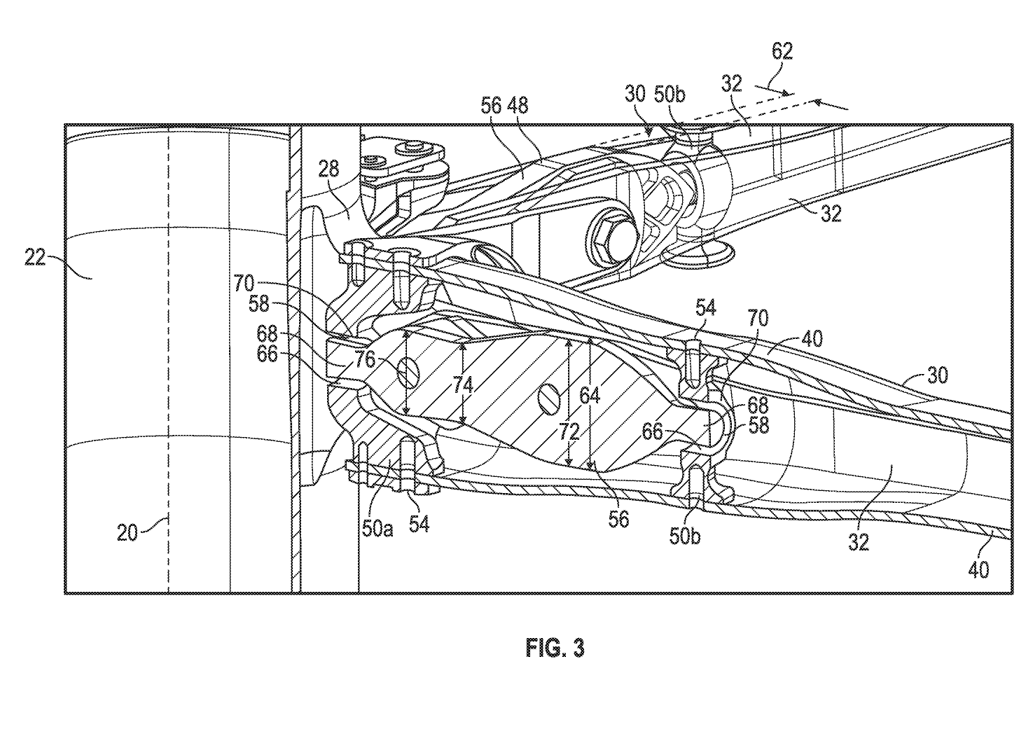

The pitch bearing assembly 48 includes two bearing outer members 50a, 50b positioned within and secured to the torque tube 40, an inboard outer member 50a and an outboard outer member 50b. In some embodiments. The bearing outer members 50a, 50b are secured to the torque tube 40 by one or more bolts (not shown) at bolt openings 54. It is to be appreciated, however, that the bearing outer members 50a, 50b may be secured to the torque tube 40 by other mechanisms and systems. A bearing inner member 56 extends between the two bearing outer members 50a, 50b into bearing races 58 of the bearing outer members 50a, 50b, and is secured to the flex beam 32 at one or more locations. In some embodiments, the bearing inner member 56 includes interface portions 68, which may be cylindrical, extending into the bearing races 58 of each of the bearing outer members 50a, 50b. Inboard of the bearing outer member 50b, a height 64 of the bearing inner member 56 along the main rotor axis 20 increases to a first peak 72. Continuing inboard, the height 64 lessens to a valley 74, then increases again to a second peak 76. Further, the bearing inner member 56 has a lateral thickness 62 which may be constant along a spanwise length of the bearing inner member 56, or which may vary. It is to be appreciated that the bearing inner member 56 shape described herein is merely exemplary and other shapes are contemplated within the scope of the present disclosure. shape described herein The bearing inner member 56 and bearing outer members 50 are typically metallic elements formed from, for example, a titanium, steel or aluminum material. In other embodiments, the bearing outer members 50 and/or the bearing inner member 56 may be formed from a composite material. One or more bearing elements 66 are located between the bearing inner member 56 and the bearing outer member 50, at an inner member interface portion 68, where the bearing inner member 56 extends into a bearing outer member opening 70. In some embodiments, the bearing elements 66 are elastomeric bearing elements 66, formed from an elastic material such as a rubber or other polymeric material, or nonpolymer elastic material, such as a metal, or combinations of polymer and nonpolymer materials, such as an arrangement of layers of elastomeric material metallic shim material therebetween. In other embodiments, the bearing elements 66 are roller or needle elements made of steel, ceramic, etc moving in a circular pattern between the bearing inner member 56 and the bearing outer member 50 at the interface portion 68. In some embodiments, each blade assembly 30 includes two flex-beam members 32. In such embodiments, as best shown in FIG. 3, the bearing inner member 56 is located laterally between the flex beam members 32 of the blade assembly 30.

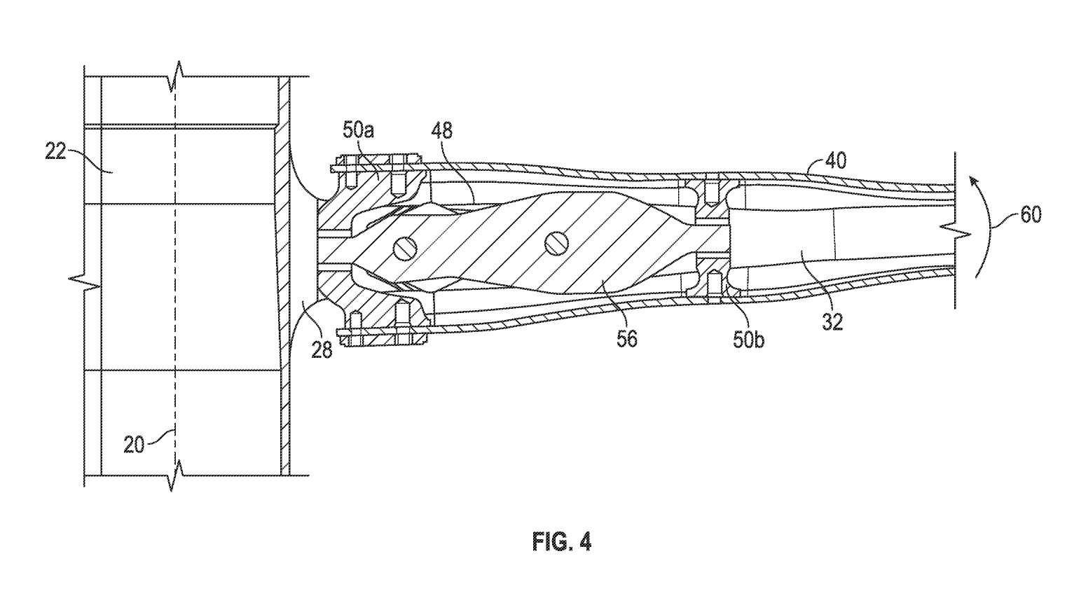

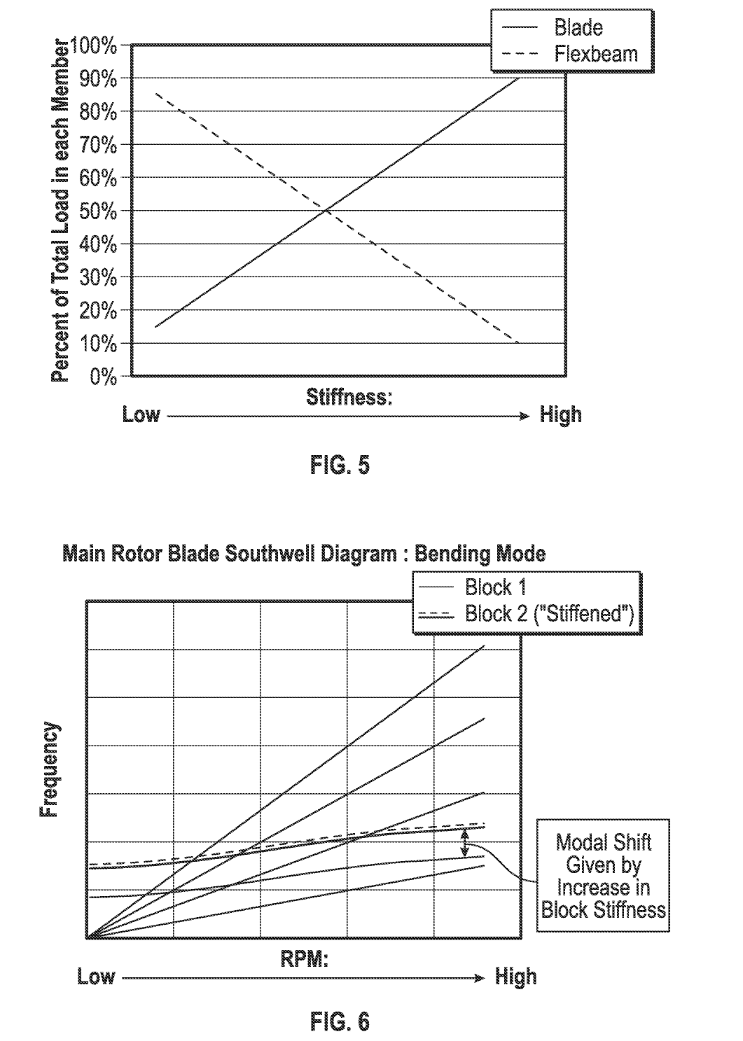

Referring now to FIG. 4, bending loads 60 on the blade assembly 30 are reacted as a couple both in the flex-beam members 32 and in the torque tube 40, since both are coupled to the pitch bearing assembly 48. Stiffness of the bearing inner member 56 determines load share between the torque tube 40 and the flex-beam members 32 and also vibration mode response of the blade assembly 30. Thus, by tuning the stiffness of the bearing inner member 56 a selected load share and vibration mode response can be achieved. For example, through shape change of the inner bearing member 56 and/or material characteristics of the inner bearing member 56. Referring again to FIG. 3, the shape change, in some embodiments, may include increasing or decreasing the lateral thickness 62 of a portion of the bearing inner member 56 and/or increasing or decreasing the height 64 of a portion of the bearing inner member 56 to change a mass and/or center of gravity of the bearing inner member 56. Further, changes in material characteristics may be accomplished by changing the material of the bearing inner member 56 or using a selected combination of metallic, composite or other materials in the bearing inner member 56 to achieve the selected characteristics. This relationship is illustrated in FIG. 5, which shows that as bearing inner member 56 stiffness increases, bending load reacted by the flex beam members 32 decreases, while bending load reacted by the torque tube 40 increases. Further, as illustrated in FIG. 6, a blade assembly 30 having relatively stiff inner bearing member 56 has an increased bending mode frequency over a blade assembly 30 having a less stiff inner bearing member 56, so it can be concluded that inner bearing member 56 stiffness has an effect on bending mode frequency of the blade assembly 30.

Blade assembly 30 response is highly sensitive to slight modifications to bearing inner member 56 stiffness, as the inner member 56 stiffness is the lowest of all the elements in the assembly. This sensitivity minimizes the need to add more complexity and or weight to the blade assembly 30 structure to achieve a selected load share and/or vibratory response.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed:

1. A rotor blade assembly comprising;
a flex-beam member;
a torque tube surrounding the flex-beam member and extending at least partially along a rotor blade assembly length; and
a pitch bearing assembly supportive of the torque tube relative to the flex-beam member including:
at least two outer bearing members secured to the torque tube; and
an inner bearing member disposed between the at least two outer bearing members and secured to the flex beam member to transfer load between the outer bearing members;
wherein a stiffness of the inner bearing member is selected to change one or more dynamic characteristics of the rotor blade assembly.

2. The rotor blade assembly of claim 1, wherein the stiffness of the inner bearing member is selected by changing a shape of the inner bearing member.

3. The rotor blade assembly of claim 1, wherein the stiffness of the inner bearing member is selected by changing a material composition of the inner bearing member.

4. The rotor blade assembly of claim 1, wherein the inner bearing member is formed from a metallic material.

5. The rotor blade assembly of claim 1, wherein the flex-beam member comprises two flex-beam members, the pitch bearing assembly disposed between the two flex beam members.

6. The rotor blade assembly of claim 5, wherein the pitch bearing assembly is disposed laterally between the two flex beam members.

7. The rotor blade assembly of claim 1, wherein the one or more dynamic characteristics include bending load share between the torque tube and the one or more flex-beam members or vibratory frequency placement.

8. A pitch bearing assembly for a blade assembly of a rotary-winged aircraft comprising:
at least two outer bearing members secured to the rotor blade assembly; and
an inner bearing member disposed between the at least two outer bearing members to transfer load between the outer bearing members;
wherein a stiffness of the inner bearing member is selected to change one or more dynamic characteristics of the rotor blade assembly.

9. The pitch bearing assembly of claim 8, wherein the stiffness of the inner bearing member is selected by changing a shape of the inner bearing member.

10. The pitch bearing assembly of claim 8, wherein the stiffness of the inner bearing member is selected by changing a material composition of the inner bearing member.

11. The pitch bearing assembly of claim 8, wherein the inner bearing member is formed from a metallic material.

12. The pitch bearing assembly of claim 8, wherein the one or more dynamic characteristics include bending load share between components of the rotor blade assembly or vibratory frequency placement.

13. A rotary-winged aircraft using the rotor blade assembly of claim 1, further comprising:
an airframe;
a drive system; and
a rotor assembly operably connected to the drive system including:
a rotor hub; and
a plurality of the rotor blade assemblies operably connected to the rotor hub

14. The aircraft of claim 13, wherein the stiffness of the inner bearing member is selected by changing a shape of the inner bearing member.

15. The aircraft of claim 13, wherein the stiffness of the inner bearing member is selected by changing a material composition of the inner bearing member.

16. The aircraft of claim 13, wherein the inner bearing member is formed from a metallic material.

17. The aircraft of claim 13, wherein the one or more flex-beam members are two flex-beam members, the pitch bearing assembly disposed between the two flex beam members.

18. The aircraft of claim 13, wherein the one or more dynamic characteristics include bending load share between the torque tube and the one or more flex-beam members or vibratory frequency placement.

19. A method of changing one or more dynamic characteristics of a rotor blade assembly comprising:
securing at least two pitch bearing outer members to a torque tube of a rotor blade assembly;
selecting a stiffness of a pitch bearing inner member to change one or more dynamic characteristics of the rotor blade assembly; and
installing the pitch bearing inner member between the at least two pitch bearing outer members; and
securing the pitch bearing inner member to a flex beam member of the rotor blade assembly, surrounded by the torque tube.

20. The method of claim 19, further comprising selecting the stiffness of the pitch bearing inner member by changing a shape of the inner bearing member.

21. The method of claim 19, further comprising selecting the stiffness of the pitch bearing inner member by changing a material composition of the inner bearing member.

22. The method of claim 19, wherein the pitch bearing inner member is formed from a metallic material.

23. The method of claim 19, wherein the one or more dynamic characteristics include bending load share between the torque tube and the one or more flex-beam members or vibratory frequency placement.
